(19) United States
(12) Patent Application Publication
(10) Pub. No.: US 2026/0087799 A1
(43) Pub. Date: Mar. 26, 2026

(54) REAL TIME AIR PERCEPTION

(71) Applicant: AUTOBRAINS TECHNOLOGIES LTD, Tel Aviv-Yafo (IL)

(72) Inventors: Igal RAICHELGAUZ, Tel Aviv (IL); Maya RAPAPORT, Tel Aviv-Yafo (IL)

(73) Assignee: AUTOBRAINS TECHNOLOGIES LTD, Tel Aviv-Yafo (IL)

(21) Appl. No.: 18/896,906

(22) Filed: Sep. 26, 2024

(51) Int. Cl. G06V 20/10; G01C 21/30; G06T 7/73; G06V 20/17

(52) U.S. Cl. CPC G06V 20/182; G01C 21/30; G06T 7/74; G06V 20/17; G06T 2207/10032; G06T 2207/20084; G06T 2207/30256

(57) ABSTRACT

A method for real time air perception, the method includes continuously obtaining, by a computerized system, aerial image signatures of patches of aerial images in accordance with a determined driving path of the vehicle, such that the patches of aerial images capture at least parts of an environment of the determined driving path for a vehicle; processing, by the computerized system and in real time, the aerial image signatures in accordance with one or more road elements within an environment along the determined driving path of the vehicle; and providing perception results, based on the processing by a classification process running with a neural network in a real time driving of the vehicle, for use in an autonomy-level driving of the vehicle.

### BACKGROUND

Vehicle environment information may be obtained by one or more sensors of the vehicle.

The angle of view of these one or more sensors is limited and fails to provide all the required information for successfully navigating or facilitating in an autonomous vehicle especially in low visibility scenarios.

There is a growing need to improve the perception of advanced driving systems and autonomous driving systems, and overall navigation of vehicles.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle according to an embodiment of the disclosure;

FIG. 2 is a flow diagram of a method according to an embodiment of the disclosure;

FIGS. 3A-3C are schematic diagrams of a system for determining a vehicle location and system components according to embodiments of the disclosure; and

FIG. 4 illustrates a ground vehicle and a plurality of vehicle sensors present in the ground vehicle.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

According to an embodiment, there is provided a method for real time air perception.

According to an embodiment the method includes continuously obtaining, by a computerized system and in real time, aerial image signatures of patches of aerial images that capture at least parts of an environment of a vehicle.

According to an embodiment, the method also includes continuously obtaining sensor signatures of sensor data captured by a sensor of the vehicle.

According to an embodiment, the method proceeds to processing, by the computerized system, the aerial image signatures in accordance with the sensor signatures of sensor data captured by the sensor of the vehicle to provide aerial-to-vehicle fused results.

According to an embodiment the aerial-to-vehicle fused results include a location of the vehicle. Additionally or alternatively, the aerial-to-vehicle fused results are indicative of road elements (including road users) within the environment of the vehicle.

According to an embodiment, the aerial-to-vehicle fused results are used to provide perception results such as detection of road elements and/or classification of the road elements and/or trajectory identification of the road users and/or trajectory prediction of the road users. Trajectory identification and/or trajectory prediction is also referred to behavioral information.

According to an embodiment, the method further includes providing perception results, using the air-to-vehicle fused results by a classification process running with a neural network in a real time driving of the vehicle, with respect to one or more road elements within the environment of the vehicle, for use in an autonomous-level based driving of the vehicle.

According to an embodiment, the providing of the perception results includes identification process and/or trajectory determination and/or trajectory prediction.

According to an embodiment, the method further includes generating, based on a classification of the road element, a driving related output with respect to the vehicle. The driving related output is used for autonomously driving the vehicle.

According to an embodiment, the outcome of the classification process is for used in advanced driver assistance system (ADAS) related to the vehicle.

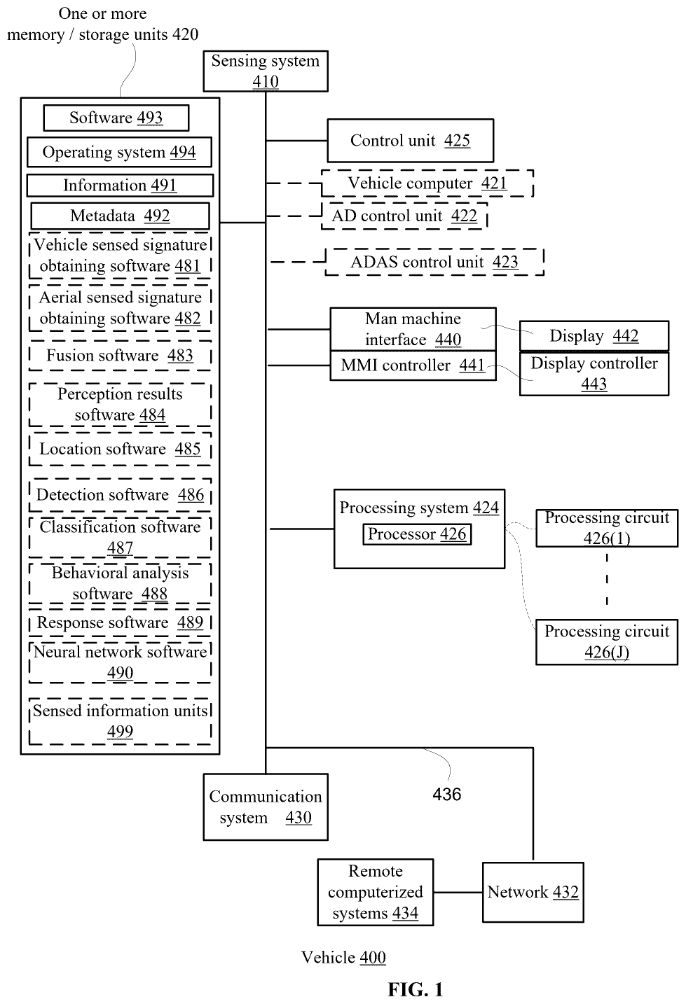

FIG. 1 illustrates an example of a vehicle 400.

Vehicle 400 includes a man machine interface 440 having or being in communication with man machine interface (MMI) controller 441 wherein in FIG. 1 the MMI is a display 442 or includes a display 442 and the MMI controller is a display controller 443 of includes the display controller 443, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, metadata 492, and software 493. Examples of software include aerial signature obtaining software 481, vehicle sensed signature obtaining software 482, fusion software 483, perception results software 484, location software 485, detection software 486, classification software 487, behavioral analysis software 488, response software 489, and neural network software 490.

FIG. 1 also illustrates information such as sensed information units 499.

The control unit 425 may cooperate with ADAS control unit 423 and/or with AD control unit 422 and/or may control or communicate with other vehicle components-including vehicle computer.

The ADAS control unit 423 is configured to control ADAS operations.

The AD control unit 422 is configured to control autonomous driving of the autonomous vehicle.

The vehicle computer 421 is configured to control the operation of the vehicle-especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform, while executing software:
Continuously obtain, by a computerized system, aerial image signatures of patches of aerial images in accordance with a determined driving path of the vehicle, such that the patches of aerial images capture at least parts of an environment of the determined driving path for a vehicle. According to an embodiment this step is executed using aerial signature obtaining software 481.
Continuously obtain sensor signatures of sensor data captured by a sensor of the vehicle. According to an embodiment this step is executed using vehicle sensed signature obtaining software 482.
Process in real time, the aerial image signatures in accordance with one or more road elements within an environment along the determined driving path of the vehicle. According to an embodiment this step is executed using fusion software 483.
Provide perception results, based on the processing by a classification process running with a neural network in a real time driving of the vehicle, for use in an autonomy-level driving of the vehicle. According to an embodiment this step is executed using at least one of perception results software 484, detection software 486 for detecting road elements, neural network software 490 for implementing the neural network, classification software 487 for classification or behavioral analysis software 488 for road elements trajectory identification and/or trajectory prediction.
Generate, based on a classification of the road element, a driving related output with respect to the vehicle. The driving related output is used for autonomously driving the vehicle. According to an embodiment this step is executed using response software 489.

Any method illustrated in the application is executable by a processor and/or processing circuit (also referred to as a processing circuitry)—an example of which is illustrated in FIG. 1.

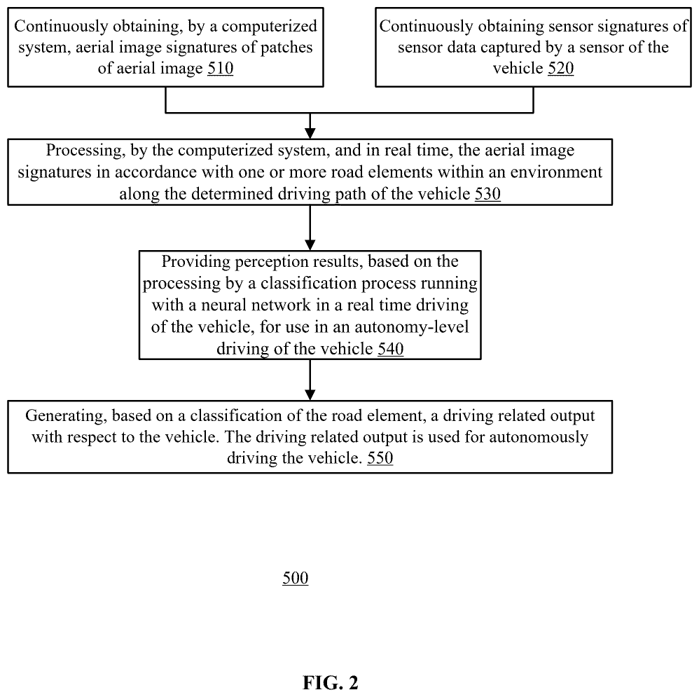

FIG. 2 illustrates an example of method 500 for real time air perception.

The term obtaining include receiving and/or generating.

According to an embodiment, method 500 includes step 510 of continuously obtaining, by a computerized system, aerial image signatures of patches of aerial images in accordance with a determined driving path of the vehicle, such that the patches of aerial images capture at least parts of an environment of the determined driving path for a vehicle. Step 510 may use aerial signature obtaining software 481.

According to an embodiment, the aerial image is an example of an aerial sensed information unit that is sensed by a non-visual aerial sensor and/or an aerial sensor that operated at a frequencies other than visible light—such as an aerial radar, an aerial sonar, an aerial magnetometer, an aerial LIDAR, an aerial ultrasonic sensor, un aerial infrared sensor, a near infrared aerial sensor, an aerial radiometer, an aerial thermal sensor, an aerial microwave sensor, an aerial x-ray sensor, an aerial gravitometer, and aerial altimeter, an aerial synthetic-aperture radar, and the like.

According to an embodiment the aerial sensed information unit is provided by one or more sensors located on one or more aerial platforms as a satellite, a drone, an airplane, a space shuttle, a helicopter, and the like.

According to an embodiment the aerial sensed information unit is provided by one or more sensors located at one or more heights, starting from a few meters to the edge of the atmosphere and even outside the atmosphere.

According to an embodiment, the aerial sensed information captures the vehicle executing method 500. According to an embodiment the vehicle can be extracted from the aerial sensed information.

According to an embodiment method 500 includes step 520 of continuously obtaining sensor signatures of sensor data captured by a sensor of the vehicle. This step may use vehicle sensed signature obtaining software 482.

According to an embodiment, step 510 and step 520 are followed by step 530 of processing, by the computerized system and in real time, the aerial image signatures in accordance with one or more road elements within an environment along the determined driving path of the vehicle. This step may use fusion software 483.

According to an embodiment the aerial-to-vehicle fused results include a location of the vehicle. An example of using aerial information and vehicle sensed information for localization of the vehicle are illustrated in U.S. patent application Ser. No. 18/527,701, titled Perception Based Driving, which is incorporated herein by reference.

According to an embodiment, the aerial-to-vehicle fused results are indicative of road elements (including road users) within the environment of the vehicle. The aerial-to-vehicle fused results are used in step 540 to provide perception results such as detection of road elements and/or classification of the road elements and/or trajectory identification of the road users and/or trajectory prediction of the road users. Trajectory identification and/or trajectory prediction is also referred to behavioral information.

According to an embodiment, step 530 is followed by step 540 of providing perception results, based on the processing by a classification process running with a neural network in a real time driving of the vehicle, for use in an autonomy-level driving of the vehicle.

Step 540 may include using at least one of perception results software 484, detection software 486, classification software 487, neural network software 490, or behavioral analysis software 488. The perception results software 484 may execute one or more functions of detection software 486, neural network software 490, classification software 487, or behavioral analysis software 488 and/or may control the execution of one or more of detection software 486, classification software 487, neural network software 490, or behavioral analysis software 488.

According to an embodiment, step 540 also include identification process and/or trajectory determination and/or trajectory prediction.

According to an embodiment, step 540 is followed by step 550 of generating, based on a classification of the road element, a driving related output with respect to the vehicle. The driving related output is used for autonomously driving the vehicle. This step may use response software 489.

According to an embodiment, the outcome of the classification process is for used in advanced driver assistance system (ADAS) related to the vehicle.

According to an embodiment, the processing of the aerial image signatures involves providing aerial-to-vehicle fused results between the aerial image signatures and sensor signatures of sensor data captured by a sensor of the vehicle.

According to an embodiment, the continuously obtaining involves downloading the aerial image signatures in accordance with the determined driving path for the vehicle.

According to an embodiment, the providing the perception results involves classifying a road element, based on the processing.

According to an embodiment, the providing of the perception results involves providing behavioral information, based on the processing, of a road users captured by the patches of the aerial images.

According to an embodiment, the providing of the perception results involves providing a prediction, based on the processing, of a future location of a road user captured by the patches of the aerial images.

According to an embodiment, the method includes determining a location of the vehicle based on, at least in part, the processing of the aerial image signatures.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.
Information about the environment of the vehicle.
A prediction of a future path of the vehicle.
A prediction of a behavior of one or more road element.
An emergency alert.
A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment and/or in the environment with re to the vehicle, an operation and/or response in compliant with one or more levels of autonomous driving—such as L2, L2+, L2++, L3 or L4 autonomous driving.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

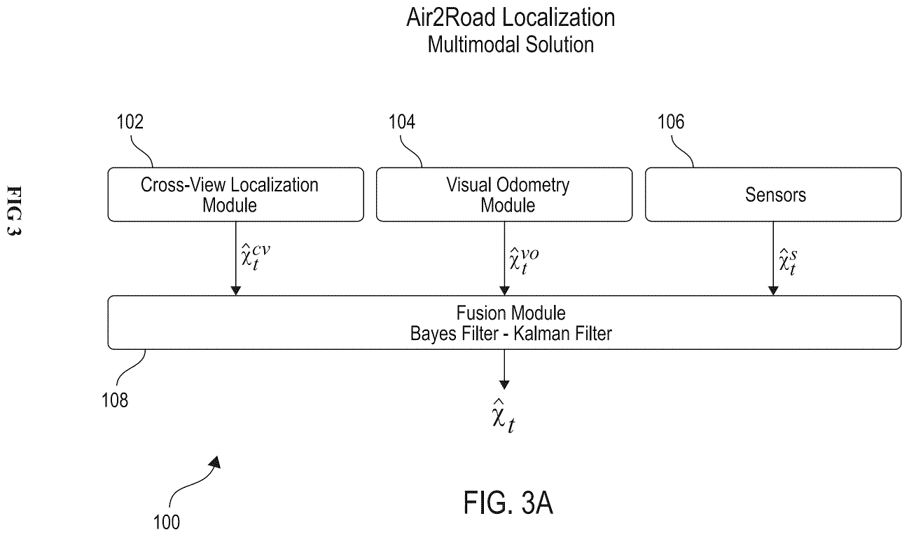

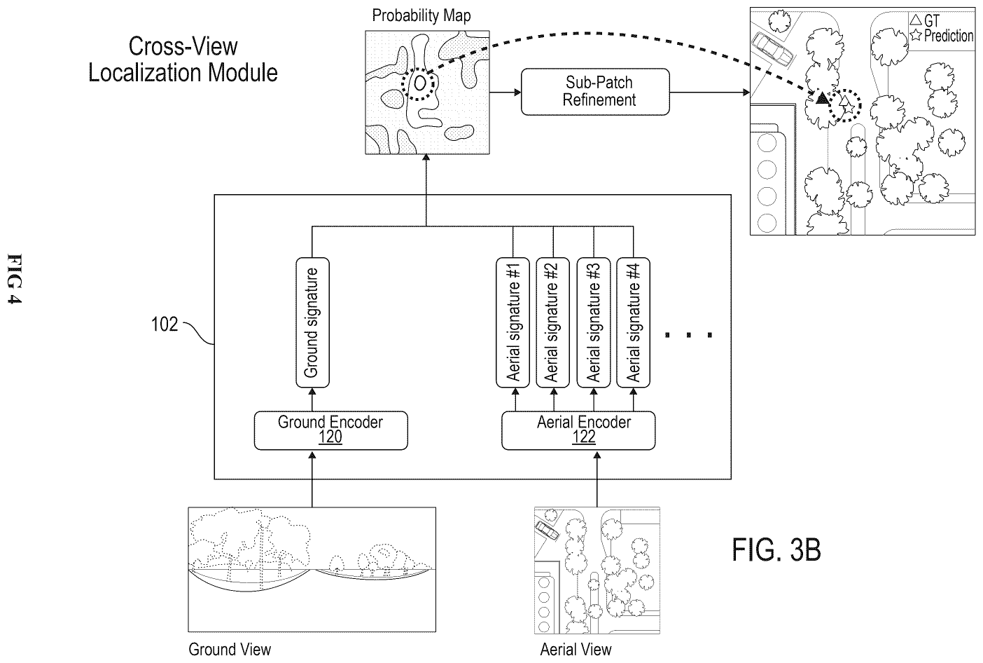

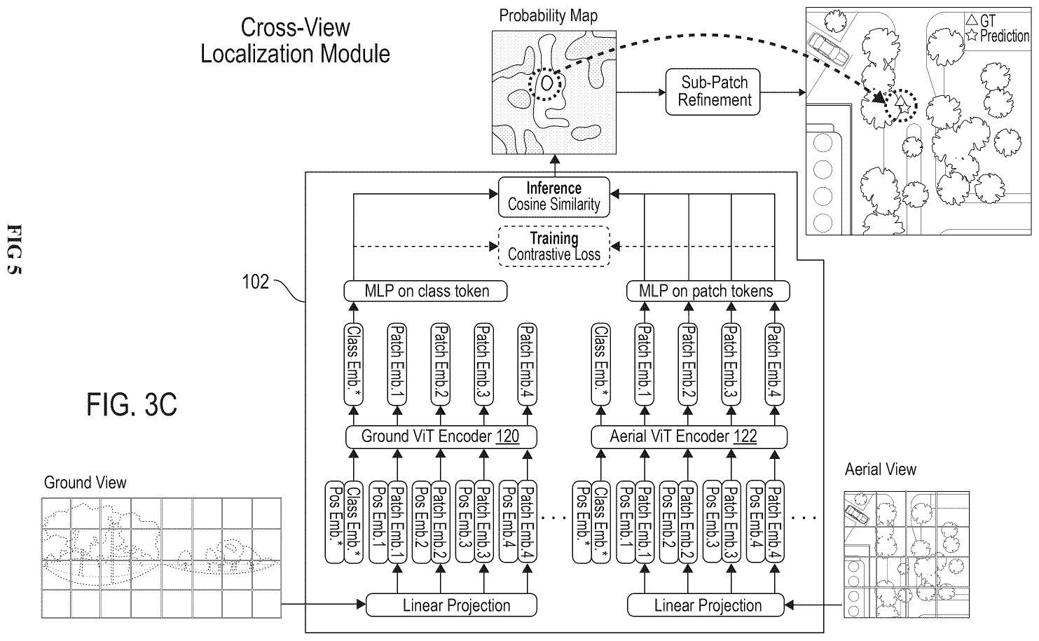

Referring now to the drawings, FIGS. 3A-3C are schematic diagrams of a system 100 for determining a vehicle location according to embodiments of the disclosure. As shown in FIG. 3A, the system 100 may include a cross-view localization module 102, a visual odometry module 104, a sensor module 106, and a fusion module 108.

Inputs into the system 100, or one or more system components, may include aerial images 216, aerial image segment signatures 218, vehicle sensed images 220 (at least some of which are acquired at different points in time), vehicle sensed image signatures 222, movement estimates 224, motion information 226, and a probabilistic location information 228, each of which shall be discussed in greater detail herein. For instance, inputs may include an image from the vehicle (for example, a 360-degree surround view image taken by a front camera of the vehicle), a satellite image, a GPS signal, and any additional information such as velocity from controller area network (CAN) signals and/or an inertial measurement unit (IMU).

Inputs may be processed by the cross-view localization module 102. FIG. 3B is a schematic diagram of the cross-view localization module 102 of FIG. 3A. The cross-view localization module 102 is configured to obtain a plurality of sensed images from, for example, a sensing unit of the vehicle and is further configured to receive a plurality of aerial images or image segments from, for example a satellite feed.

As is further illustrated in FIG. 3B, the cross-view localization module 102 is configured to obtain a plurality of aerial images or aerial image segments. According to embodiments of the disclosure, the cross-view localization module 102 may be configured to receive a plurality of aerial images or image segments of a region in which the vehicle is located. To this end, the cross-view localization module 102 is configured to receive a plurality of inputs from one or more outside-the-vehicle sources. Outside-the-vehicle sources may include satellite images or GPS location information.

A coverage area (i.e., a specified image capture area) for a captured aerial image segment may be determined. The required coverage area of a specified image capture area may be determined in advance or in a dynamic manner. For example, if the ground vehicle is located in an urban area, or another area that exhibits a high density of objects, then the aerial image coverage area may be reduced. Alternatively, if the ground vehicle is located in a rural, desolate, isolated or other area only sparsely populated with objects, then the aerial image coverage area may be increased. Modifications to the coverage area may be assisted by coarse location information of the ground vehicle. Such coarse location information may be received from, for example, by as a global positioning satellite (GPS) system, a cellular location system, and the like.

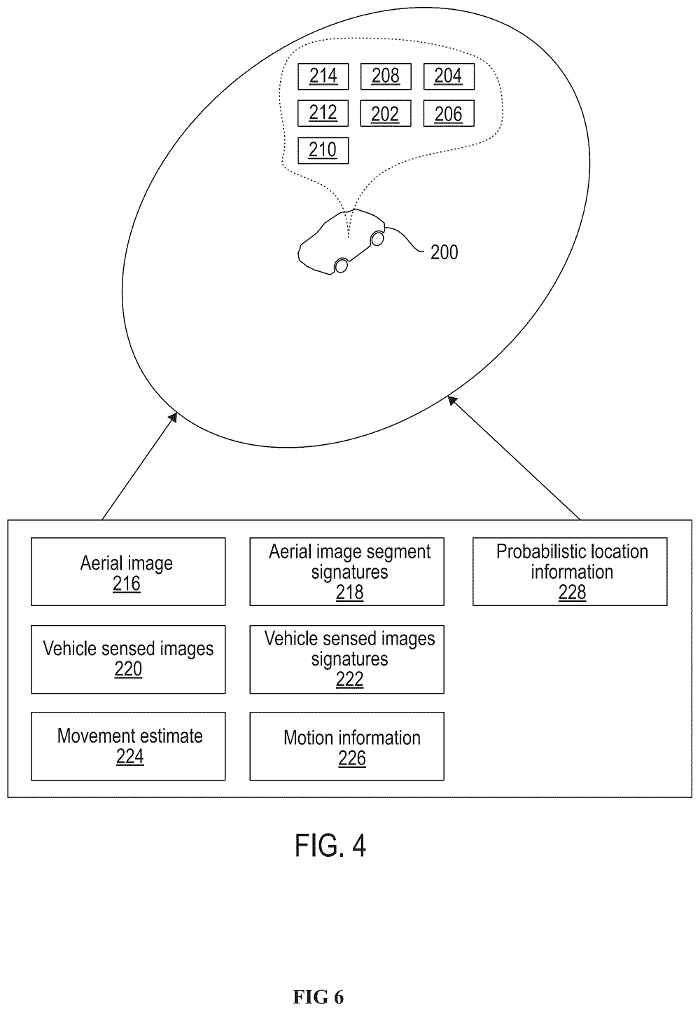

The cross-view localization module 102 is further configured to receive a plurality of sensed images. To this end, the system 100 is configured to receive a plurality of sensed inputs from one or more in-vehicle sources. FIG. 4 illustrates a ground vehicle 200 including a plurality of components. According to embodiments of the disclosure, a ground vehicle 200 including the location system 100 as described herein may include a vehicle sensing unit 202 that further includes one or more sensors such as vehicle sensors 204 and 206. The vehicle sensors 204, 206 may include multiple image sensors and one or more non-image sensors. The vehicle sensors 204, 206 may be image capture devices (such as cameras), audio sensors, infrared sensors, radar, ultrasound sensors, electro-optics sensors, radiography sensors, Lidar (light detection and ranging) sensors, thermal sensor sensors, passive sensors, active sensors, etc. The plurality of sensed images may be received at a plurality of time intervals.

The ground vehicle 200 may also include one or more processing circuits 208, memory unit 210, communication unit 212, and one or more vehicle units 214 such as one or more vehicle computers, units controlled by the one or more vehicle units, motor units, chassis, wheels, and the like. The one or more processing circuits 208 are configured to execute the systems and methods disclosed herein.

According to an embodiment, the ground vehicle sensed images are 360-degree ground vehicle sensed images. In this instance, each ground vehicle sensed image covers a 360-degree sample of the environment of the ground vehicle. According to an embodiment, the ground vehicle sensed images cover less than 360 degrees. Including a broader coverage area in the ground vehicle sensed image may increase the accuracy of the location detection. Including a narrower coverage area in the ground vehicle sensed image may require less bandwidth and may therefore be less expensive to execute.

According to an embodiment, a sensed image is generated by acquiring a plurality of ground vehicle sensed images. The ground vehicle sensed images may be of different angular segments of a vehicle's field of view. The different angular segments may be acquired by different image sensors having different fields of views (differ by at least by their polar angle coverage), and/or may be acquired by scanning the environment of the ground vehicle—for example using movable image sensors or image sensors preceded by optics of an adjustable field of view. The plurality of ground vehicle sensed images may be captured in close-timing proximity (e.g., within a fraction of a second from each other). The plurality of ground vehicle sensed images, or at least a portion of the visual information contained therein, may then be stitched or otherwise combined to provide a 360-degree ground vehicle sensed images.

The sensed images and aerial images may be translated into image signatures, by for example, a processor (e.g., the cross-view localization module 102). An image signature of a detected region (e.g., a ground vehicle-sensed image or an aerial image) may be defined as information regarding one or more other regions of the image.

To generate the image signatures from sensed images and/or aerial images or image segments, the cross-view localization module 102 may include a ground encoder 120 and an aerial encoder 122. The ground encoder 120 is configured to extract a sensed image signature (e.g., a ground-vehicle image signature) from an image captured by a vehicle sensor. The sensed image signature contains ground image information of a captured image segment that is needed to perform a comparison between the image segment and at least one additional input (e.g., a satellite image). A plurality of sensed image signatures may be obtained at a plurality of time intervals.

The aerial encoder 122 extracts a plurality of aerial image signatures from, for example, received satellite images. Aerial image segment signatures are composed of information relating to aerial image segments of a region in which a vehicle may be located (i.e., the specified image capture area). Each aerial image signature includes information regarding the selected specified image capture area. Signatures of an aerial segment or a subsegment of an aerial segment (e.g., a segment patch) may be generated by applying a self-attention mechanism to the segment or the segment patch. A self-attention mechanism may be a mechanism that computes attention scores between patches, based, for example, on the content and position of an object in the image. The self-attention mechanism may be included in a transformer neural network.

The cross-view localization module 102 is also configured to match an aerial image segment signature of the plurality of aerial image segment signatures to a sensed image signature of the plurality of sensed image signatures. As shown in FIG. 3C, a process for matching a sensed (ground) image signature to an aerial image signature is shown. Prior to input into the cross-view localization module 102, the ground view image and the aerial image may be divided into one or more sections or a grid. Once an image is input into the cross-view localization module 102, in, for instance, a grid formed from individual image segments, a linear projection of the one or more grid segments may be calculated. A ground view image class embedding and position embedding, as well as a plurality of ground position and patch embeddings may be created from the linear projection. Similarly, an aerial image class and position embedding, and a plurality of aerial position and patch embeddings may be created from the linear projection.

The respective class/position embeddings and position/patch embeddings may be fed into the ground encoder 120 and the aerial encoder 122, respectively. In such instances, the ground encoder 120 and the aerial encoder 122 may be Vision Transformer (ViT) encoders or may leverage another like deep learning architecture. The output of the ground encoder 120 may be a ground image class token and a plurality of ground image patch tokens. The output of the aerial encoder 122 may be an aerial image class token and a plurality of aerial image patch tokens. A multi-layer perceptron function may be performed on the ground encoder class token and the plurality of aerial patch tokens.

The system is trained with attention mechanisms to locate the best representations and matching between aerial image signatures and sensed image signatures. For instance, the cross-view localization module 102 may apply a contrastive loss function to the input tokens. In such instances, the training process may include feeding the machine learning process with ground vehicle sensed images at different points in time and corresponding aerial images. The training process may cause the machine learning process to provide a mapping between the vehicle sensed image signatures and the aerial image segment signatures. The training process may also induce training the machine learning process to (i) provide a similar signature to a ground vehicle sensed image of a region and an aerial image segment signature of that region, and (ii) provide dissimilar signatures to a ground vehicle sensed image and an aerial image segment of different regions. In some instances, the training process relies on a neural network such as an attention mechanism. Other functions configured to determine how well a model can differentiate between similar and dissimilar data points may be utilized.

During an inference phase,, a cosine similarity function may be applied. Other functions configured to a measure of similarity between two non-zero vectors defined in an inner product space may be utilized.

Probabilistic location information is then generated from the processing steps performed by the cross-view localization module 102. For instance, the cross-view localization module 102 is further configured to generate probabilistic location information (e.g., a probability map) regarding the location of the vehicle during the plurality of time intervals. The probabilistic location information is based on the matching of the aerial image segment signature and the sensed image signature. For example, the sensed image signature and the aerial image signature are compared against each other to create probabilistic location information. As mentioned above, the aerial image signatures input into the cross-view localization module 102 may be constructed during training such that they contain relevant data from other patches of the satellite image. This may be executed by utilizing a self-attention mechanism, i.e., a mechanism that computes attention scored between patches, based, for example, on content and position in the image. Determining a probabilistic location of the ground vehicle includes determining the location information at a sub-patch resolution. A sub-patch refinement module may be applied to accurately estimate the location of the camera in the satellite image. For instance, with respect to a received satellite patch, one or more satellite patch neighbors may be fused to indicate where inside the patch the location probability is the highest. Alternatively, up-sampling (i.e., using an up-sampled version of the aerial image) may be utilized on the satellite image.

According to an embodiment, the probabilistic location information is a heatmap. A color of a heatmap pixel is indicative of a probability that the vehicle is located at the heatmap pixel. For instance, a high concentration of red pixels may indicate a high location probability.

The system is further configured to obtain a movement estimate of the vehicle during the plurality of time intervals. In some embodiments, the movement estimate may be obtained from the visual odometry module 104. For example, the visual odometry module 104 may be configured to analyze a plurality of sensed images received from a vehicle sensor (e.g., one or more of sensors 204, 206). The movement estimate is generated based on a vehicle location comparison across the plurality of sensed images. For instance, the visual odometry module 104 may detect an object in a first received image. The visual odometry module 104 may then search for the object in subsequent images and calculate or estimate vehicle movement information from the differences in position of the detected object. The object may be stationary to allow for a comparison of the vehicle in motion to the object at discrete time intervals. In some embodiments, velocity information may be extracted from controller area network (CAN) signals. The visual odometry module 104 may then use the received inputs to update vehicle location as the vehicle traverses a path.

According to an embodiment, motion information may be gained from non-image sensors of the ground vehicle. The system may further comprise a sensor module 106 configured to receive inputs from a plurality of sensors (examples of which are described above in FIG. 4). The motion information may therefore be obtained by at least one sensor, such as a vehicle direction or propagation sensor (e.g., a sensor configured to determine the direction of propagation of the vehicle), an accelerometer, and the like. Sensor module information may be combined with the cross-view localization module output and/or the visual odometry output.

The system 100 is further configured to determine the location of the vehicle by fusing or combining the movement estimate of the vehicle and the probabilistic location information. For instance, the fusion module 108 may combine or fuse input location information. The fusion module 108 may be a particle filter, such as a Bayes filter or a Kalman filter.

According to an embodiment a heatmap from the cross-view localization module and movement information from the visual odometry module are fused or combined to form a fusion module depiction of a vehicle location. Determining the location of the ground vehicle may be based on, or solely on, a combination or fusing of the movement estimate of the ground vehicle, the probabilistic location information and coarse ground vehicle location information. Alternatively, determining the location of the ground vehicle may be based on, or solely on, a combination or fusing of the movement estimate of the ground vehicle, the probabilistic location information and motion information gained from non-image sensors of the ground vehicle. Determining the location of the ground vehicle may be based on, or solely on, a combination or fusing of the movement estimate of the ground vehicle, the probabilistic location information, motion information gained from non-image sensors of the ground vehicle and coarse ground vehicle location information.

According to an embodiment, the fusing is executed by a machine learning process of the fusion module, the machine learning process has undergone a training process in which it learns to fuse outputs from the cross-view localization module and the visual odometry module.

Determining the location of the ground vehicle may further include triggering a determination of an autonomous driving operation. Thus, the determining the location of the ground vehicle may further include determining the autonomous driving operation, and/or executing the autonomous driving operation. According to embodiments of the disclosure, the autonomous driving operation includes at least one of autonomously controlling a speed and/or direction of propagation and/or acceleration of a vehicle. The autonomous driving operation may also be an emergency breaking operation, a lane maintaining driving operation, a lane changing driving operation, and the like.

A resultant location indication may be accurate to a sub-10 cm offset. The system is able to perform vehicle localization in any location without the need for the particular road to have been driven by the vehicle previously. The system 100 may be configured to execute offline, by leveraging highly compressed aerial image signatures stored in the system.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

1. A method of real time air perception, comprising:
continuously obtaining, by a computerized system, aerial image signatures of patches of aerial images in accordance with a determined driving path of a vehicle, such that the patches of aerial images capture at least parts of an environment of the determined driving path for the vehicle;
processing, by the computerized system and in real time, the aerial image signatures in accordance with one or more road elements within an environment along the determined driving path of the vehicle; and
providing perception results, based on the processing by a classification process running with a neural network in a real time driving of the vehicle, for use in an autonomy-level driving of the vehicle.

2. The method according to claim 1, wherein the processing of the aerial image signatures involves providing aerial-to-vehicle fused results between the aerial image signatures and sensor signatures of sensor data captured by a sensor of the vehicle.

3. The method according to claim 1, wherein the continuously obtaining involves downloading the aerial image signatures in accordance with the determined driving path for the vehicle.

4. The method according to claim 1, wherein providing the perception results involves classifying a road element, based on the processing.

5. The method according to claim 1, wherein providing the perception results involves providing behavioral information, based on the processing, of a road users captured by the patches of the aerial images.

6. The method according to claim 1, wherein providing the perception results involves providing a prediction, based on the processing, of a future location of a road user captured by the patches of the aerial images.

7. The method according to claim 1, further comprising determining a location of the vehicle based on, at least in part, the processing of the aerial image signatures.

8. A non-transitory computer readable medium of real time air perception, that stores instructions executable by a processor for:
continuously obtaining, by a computerized system, aerial image signatures of patches of aerial images in accordance with a determined driving path of a vehicle, such that the patches of aerial images capture at least parts of an environment of the determined driving path for the vehicle;
processing, by the computerized system and in real time, the aerial image signatures in accordance with one or more road elements within an environment along the determined driving path of the vehicle; and
providing perception results, based on the processing by a classification process running with a neural network in a real time driving of the vehicle, for use in an autonomy-level driving of the vehicle.

9. The non-transitory computer readable medium according to claim 8, wherein the processing of the aerial image signatures involves providing aerial-to-vehicle fused results between the aerial image signatures and sensor signatures of sensor data captured by a sensor of the vehicle.

10. The non-transitory computer readable medium according to claim 8, wherein the continuously obtaining involves downloading the aerial image signatures in accordance with the determined driving path for the vehicle.

11. The non-transitory computer readable medium according to claim 8, wherein providing the perception results involves classifying a road element, based on the processing.

12. The non-transitory computer readable medium according to claim 8, wherein providing the perception results involves providing behavioral information, based on the processing, of a road users captured by the patches of the aerial images.

13. The non-transitory computer readable medium according to claim 8, wherein providing the perception results involves providing a prediction, based on the processing, of a future location of a road user captured by the patches of the aerial images.

14. The non-transitory computer readable medium according to claim 8, further storing instructions executable by a processor for determining a location of the vehicle based on, at least in part, the processing of the aerial image signatures.
